(19) United States
(12) Patent Application Publication
(10) Pub. No.: US 2021/0297608 A1
(43) Pub. Date: Sep. 23, 2021

(54) OPTICAL RECOGNITION SYSTEM FOR USE IN COMPUTER VISUAL PROCESSING

(71) Applicant: WELTREND SEMICONDUCTOR INC., Hsinchu (TW)

(72) Inventors: Ching-Hsuan Ma, Hsinchu (TW); Meng-Che Tsai, Hsinchu (TW); Hsi-Chun Huang, Hsinchu (TW)

(21) Appl. No.: 16/876,090

(22) Filed: May 17, 2020

(30) Foreign Application Priority Data
Mar. 23, 2020 (TW) 109109643

(51) Int. Cl. H04N 5/341; H04N 7/01; G06T 3/40

(52) U.S. Cl. CPC H04N 5/341; G06T 3/4007; H04N 7/0135

(57) ABSTRACT

An optical recognition system includes a 4×4 kernel image sensor, two line buffers, and an interpolation unit. The 4×4 kernel image sensor includes two red pixels, eight green pixels, two blue pixels, and four IR pixels arranged in Bayer pattern. The two line buffers are configured to store the brightness information of the pixels. The interpolation unit is configured to provide missing components in each pixel according to the brightness information stored in the two line buffers, thereby outputting an image data which includes full-color brightness information associated with each pixel.

### CROSS REFERENCE TO RELATED APPLICATION

This application claims priority of Taiwan Application No. 109109643 filed on 2020 Mar. 23.

### BACKGROUND OF THE INVENTION

### 1. Field of the Invention

The present invention is related to an optical recognition system for use in computer visual processing, and more particularly, to an optical recognition system having 4×4 kernel image sensors for use in computer visual processing.

### 2. Description of the Prior Art

Image sensors are widely used in consumer products for converting optical images into electrical signals, thereby generating color images. An image sensor typically includes photo-sensitive devices such as charge-coupled devices (CCD) or CMOS active pixel sensors for light detection, as well as a filter array arranged in a specific pattern for gathering the brightness information of each color. Next, full-color images may be provided by performing interpolation and correction on the brightness information.

FIG. 1 is a diagram illustrating a 2×2 kernel image sensor in a prior art optical recognition system. The 2×2 kernel image sensor P includes a red pixel R, a green pixel G, a blue pixel B and an infrared (IR) pixel IR, wherein the missing components in each pixel may be provided by performing interpolation based on neighboring pixels. For example, the green component of the red pixel R may be provided by performing interpolation based on the brightness information associated with the green pixel G, the blue component of the red pixel R may be provided by performing interpolation based on the brightness information associated with the blue pixel B, and the IR component of the red pixel may be provided by performing interpolation based on the brightness information associated with the IR pixel IR.

However, the prior art recognition system is designed for human eyes wherein may line buffers are required for storing the brightness information on multiple scan lines so as to perform interpolation on RGB images and IR images. Also, the prior art recognition system needs to implement complicated algorithms in order to provide sufficient image characteristics for human eyes to perform image recognition.

### SUMMARY OF THE INVENTION

The present invention provides an optical recognition system for use in computer visual processing. The optical recognition system includes an image capturing device, an interpolation unit and an interpolation unit. The image capturing device includes a 4×4 kernel image sensor which includes a first red pixel, a second red pixel, a first through an eighth green pixels, a first blue pixel, a second blue pixel, and a first through a fourth IR pixels forming a first through a fourth scan lines adjacent to each other. The buffer unit is configured to store brightness information of at least two scan lines among the first through the fourth scan lines. The interpolation unit is configured to provide missing components in each pixel according to the brightness information stored in the buffer unit, thereby outputting an image data which includes full-color brightness information associated with each pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 2×2 kernel image sensor in a prior art optical recognition system.

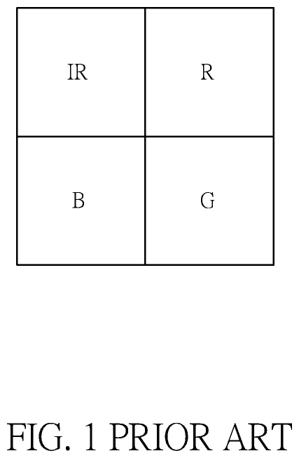

FIG. 2 is a function diagram illustrating an optical recognition system for use in computer visual processing according to an embodiment of the present invention.

FIG. 3 is a function diagram illustrating an optical recognition system for use in computer visual processing according to another embodiment of the present invention.

FIG. 4 is a diagram illustrating an implementation of the image capturing device according to an embodiment of the present invention.

FIG. 5 is a diagram illustrating an 4×4 kernel image sensor PX(n, m) located on the m^{th} column and the n^{th} row of the image capturing device according to an embodiment of the present invention.

### DETAILED DESCRIPTION

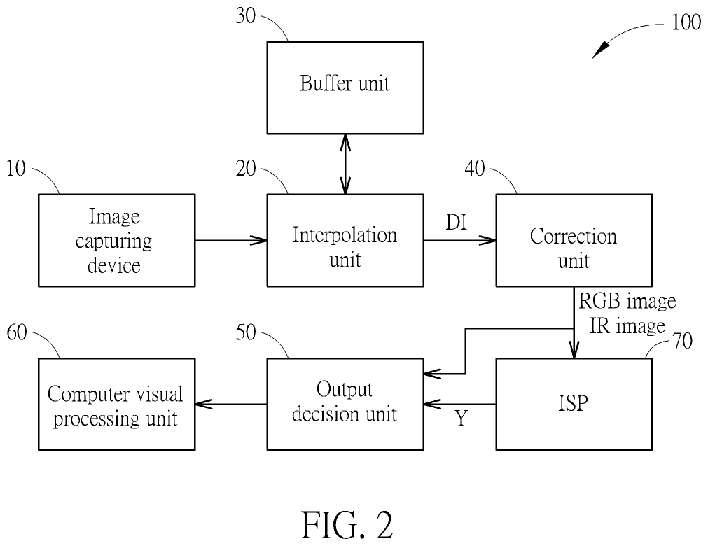

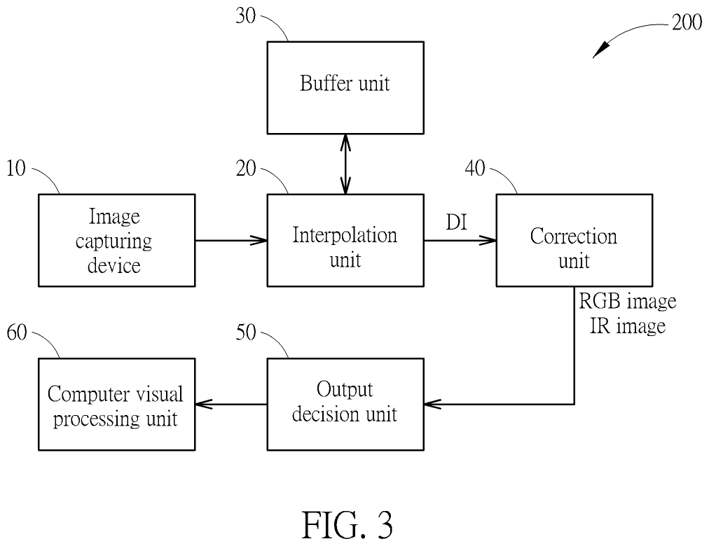

FIG. 2 is a function diagram illustrating an optical recognition system 100 for use in computer visual processing according to an embodiment of the present invention. FIG. 3 is a function diagram illustrating an optical recognition system 200 for use in computer visual processing according to another embodiment of the present invention. Each of the optical recognition systems 100 and 200 includes an image capturing device 10, an interpolation unit 20, a buffer unit 30, a correction unit 40, an output decision unit 50, and a computer visual processing unit 60. The optical recognition system 100 further includes an image signal processor (ISP) 70.

In the optical recognition systems 100 and 200, the image capturing device 10 includes one or multiple 4×4 kernel image sensors each consist of optical sensors and filter arrays. Each 4×4 kernel image sensor includes a plurality of red pixels, a plurality of green pixels, a plurality of blue pixels, and a plurality of IR pixels arranged in a Bayer pattern and forming four adjacent scan lines.

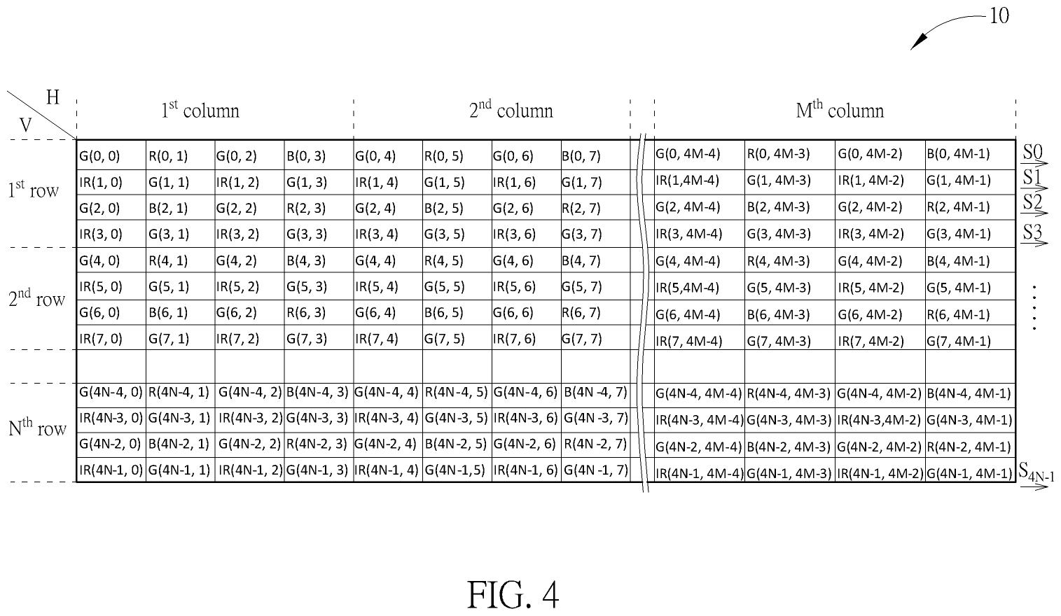

FIG. 4 is a diagram illustrating an implementation of the image capturing device 10 according to an embodiment of the present invention. The image capturing device 10 may include multiple 4×4 kernel image sensors arranged in a matrix with M columns of 4×4 kernel image sensors along the horizontal direction (designated by H) and N rows of 4×4 kernel image sensors along the vertical direction (designated by V), wherein M and N are integers larger than 1. Each 4×4 kernel image sensor includes two red pixels, eight green pixels, two blue pixels, and four IR pixels, wherein R represents red pixels, G represents green pixels, B represents blue pixels, IR represents IR pixels, and the numbers in the parenthesis represent the coordinate of each pixel. The number of green pixels is larger than the number of red pixels or blue pixels in order to reflect different sensibilities to visible light, wherein human eye are most sensitive to green light, medium sensitive to red light and least sensitive to blue light. For illustrative purposes, it is assumed that the image capturing device 10 scans in the horizontal direction, wherein the scan lines are represented by S₀˜S_{4N-1} with the arrow direction corresponding to the scan direction.

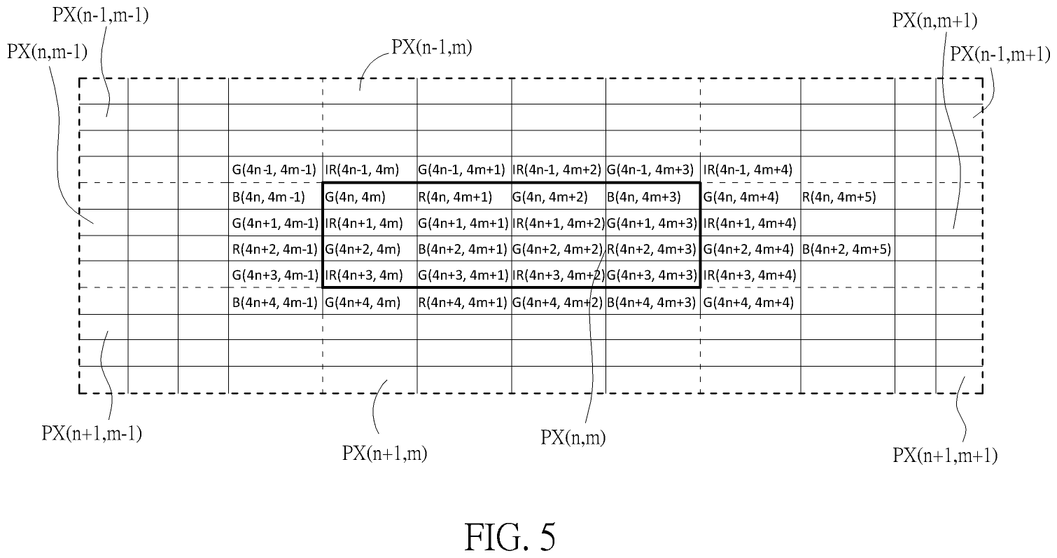

FIG. 5 is a diagram illustrating an 4×4 kernel image sensor PX(n,m) located on the M^{th} column and the n^{th} row of the image capturing device 10 according to an embodiment of the present invention. The 4×4 kernel image sensor PX(n,m) includes two red pixels R(4n,4m+1) and R(4n+2,4m+3), eight green pixels G (4n, 4m), G (4n, 4m+2), (4n+1,4m+1), G(4n+1,4m+3), G(4n+2,4m), G(4n+2,4m+2), G(4n+3,4m+1) and G(4n+3, 4m+3), two blue pixels B (4n, 4m+3) and (4n+2,4m+1), and four IR pixels IR(4n+1,4m), IR(4n+1,4m+2), IR(4n+3,4m) and IR(4n+3,4m+2), wherein M and N are integers larger than 3, n is an integer between 1 and M, and n is an integer between 1 and N. For illustrating the method of performing interpolation on each coordinate in the 4×4 kernel image sensor PX(n,m), FIG. 5 further depicts all required pixels in the six 4×4 kernel image sensors PX(n−1,m−1), PX(n−1,m), PX(n−1,m+1), PX(n,m−1), PX(n,m+1), PX(n+1, m−1), PX(n+1,m) and PX(n+1,m+1) adjacent to the 4×4 kernel image sensor PX(n,m).

In an embodiment of the present invention, the buffer unit 30 in the optical recognition systems 100 and 200 includes two line buffers. Therefore, for the coordinate of a red pixel in the 4×4 kernel image sensor PX(n,m), its red component may be provided based on the brightness information associated with the coordinate of the red pixel, its green component may be provided by performing interpolation based on the brightness information associated with four green pixels adjacent to the coordinate of the red pixel, its blue component may be provided by performing interpolation based on the brightness information associated with two blue pixels nearest to the coordinate of the red pixel along the horizontal direction, and its IR component may be provided by performing interpolation based on the brightness information associated with four IR pixels nearest to the coordinate of the red pixel.

For the coordinate of a green pixel in the 4×4 kernel image sensor PX(n,m), its red component may be provided by performing interpolation based on the brightness information associated with the red pixel adjacent to the coordinate of the green pixel along the horizontal direction or the vertical direction, its green component may be provided based on the brightness information associated with the coordinate of the green pixel, its blue component may be provided by performing interpolation based on the brightness information associated with the blue pixel adjacent to the coordinate of the green pixel along the horizontal direction or the vertical direction, and its IR component may be provided by performing interpolation based on the brightness information associated with the two IR pixels adjacent to the coordinate of the green pixel along the horizontal direction or the vertical direction.

For the coordinate of a blue pixel in the 4×4 kernel image sensor PX(n,m), its red component may be provided by performing interpolation based on the brightness information associated with two red pixels nearest to the coordinate of the blue pixel along the horizontal direction, its green component may be provided by performing interpolation based on the brightness information associated with four green pixels adjacent to the coordinate of the blue pixel along the horizontal direction and the vertical direction, its blue component may be provided based on the brightness information associated with the coordinate of the blue pixel, and its IR component may be provided by performing interpolation based on the brightness information associated with four IR pixels nearest to the coordinate of the blue pixel.

For the coordinate of an IR pixel in the 4×4 kernel image sensor PX(n,m), its red component may be provided by performing interpolation based on the brightness information associated with the two red pixels nearest to the coordinate of the IR pixel, its green component may be provided by performing interpolation based on the brightness information associated with the four green pixels adjacent to the coordinate of the IR pixel along the horizontal direction and the vertical direction, its blue component may be provided by performing interpolation based on the brightness information associated with the two blue pixels nearest to the coordinate of the IR pixel, and its IR component may be provided based on the brightness information associated with the coordinate of the IR pixel.

More specifically, the interpolation method of providing the red component R′(4n,4m), the green component G′(4n,4m), the blue component B′(4n, 4m) and the IR component IR′(4n, 4m) for the green pixel at the coordinate (4n,4m) may be illustrated by the following equations:

R′(4n,4m)=R(4n,4m+1)

G′(4n,4m)=G(4n,4m)

B′(4n,4m)=B(4n,4m−1)

IR′(4n,4m)=[IR(4n−1,4m)+IR(4n+1,4m)]/2

The interpolation method of providing the red component R′(4n,4m+1), the green component G′(4n,4m+1), the blue component B′(4n,4m+1) and the IR component IR′(4n,4m+1) for the red pixel at the coordinate (4n,4m+1) may be illustrated by the following equations:

R′(4n,4m+1)=R(4n,4m+1)

G′(4n,4m+1)=[G(4n−1,4m+1)+G(4n,4m)+G(4n,4m+2)+G(4n+1,4m+1)]/4

B′(4n,4m+1)=[B(4n,4m−1)+B(4n,4m+3)]/2

IR′(4n,4m+1)=[IR(4n−1,4m)+IR(4n−1,4m+2)+IR(4n+1,4m)+IR(4n+1,4m+2)]/4

The interpolation method of providing the red component R′(4n,4m+2), the green component G′(4n,4m+2), the blue component B′(4n,4m+2) and the IR component IR′(4n,4m+2) for the green pixel on the coordinate (4n,4m+2) may be illustrated by the following equations:

R′(4n,4m+2)=R(4n,4m+1)

G′(4n,4m+2)=G(4n,4m+2)

B′(4n,4m+2)=B(4n,4m+3)

IR′(4n,4m+2)=[IR(4n−1,4m+2)+IR(4n+1,4m+2)]/2

The interpolation method of providing the red component R′(4n,4m+3), the green component G′(4n,4m+3), the blue component B′(4n,4m+3) and the IR component IR′(4n,4m+3) for the blue pixel at the coordinate (4n,4m+3) may be illustrated by the following equations:

R′(4n,4m+3)=[R(4n,4m+1)+R(4n,4m+5)]/2

G′(4n,4m+3)=[G(4n−1,4m+3)+G(4n,4m+2)+G(4n,4m+4)+G(4n+1,4m+3)]/4

B′(4n,4m+3)=B(4n,4m+3)

IR′(4n,4m+3)=[IR(4n−1,4m+2)+IR(4n−1,4m+4)+IR(4n+1,4m+2)+IR(4n+1,4m+4)]/4

The interpolation method of providing the red component R′(4n+1,4m), the green component G′(4n+1,4m), the blue component B′(4n+1,4m) and the IR component IR′(4n+1,4m) for the IR pixel at the coordinate (4n+1,4m) may be illustrated by the following equations:

R′(4n+1,4m)=[R(4n,4m+1)+R(4n+2,4m−1)]/2

G′(4n+1,4m)=[G(4n,4m)+G(4n+1,4m−1)+G(4n+1,4m+1)+G(4n+2,4m]/4

B′(4n+1,4m)=[B(4n,4m−1)+B(4n+2,4m+1)]/2

IR′(4n+1,4m)=IR(4n+1,4m)

The interpolation method of providing the red component R′(4n+1,4m+1), the green component G′ (4n+1,4m+1), the blue component B′(4n+1,4m+1) and the IR component IR′(4n+1,4m+1) for the green pixel at the coordinate (4n+1,4m+1) may be illustrated by the following equations:

R′(4n+1,4m+1)=R(4n,4m+1)

G′(4n+1,4m+1)=G(4n+1,4m+1)

B′(4n+1,4m+1)=B(4n+2,4m+1)

IR′(4n+1,4m+1)=[IR(4n+1,4m)+IR(4n+1,4m+2)]/2

The interpolation method of providing the red component R′(4n+1,4m+2), the green component G′ (4n+1,4m+2), the blue component B′(4n+1,4m+2) and the IR component IR′(4n+1,4m+2) for the IR pixel at the coordinate (4n+1,4m+2) may be illustrated by the following equations:

R′(4n+1,4m+2)=[R(4n,4m−1)+R(4n+2,4m+3)]/2

G′(4n+1,4m+2)=[G(4n,4m+2)+G(4n+1,4m+1)+G(4n+1,4m+3)+G(4n+2,4m+2]/4

B′(4n+1,4m+2)=[B(4n,4m+3)+B(4n+2,4m+1)]/2

IR′(4n+1,4m+2)=IR(4n+1,4m+2)

The interpolation method of providing the red component R′(4n+1,4m+3), the green component G′ (4n+1,4m+3), the blue component B′(4n+1, 4m+3) and the IR component IR′(4n+1, 4m+3) for the green pixel at the coordinate (4n+1,4m+3) may be illustrated by the following equations:

R′(4n+1,4m+3)=R(4n+2,4m+3)

G′(4n+1,4m+3)=G(4n+1,4m+3)

B′(4n+1,4m+3)=B(4n,4m+3)

IR′(4n+1,4m+3)=[IR(4n+1,4m+2)+IR(4n+1,4m+4)]/2

The interpolation method of providing the red component R′(4n+2,4m), the green component G′(4n+2,4m), the blue component B′(4n+2,4m) and the IR component IR′(4n+2,4m) for the green pixel at the coordinate (4n+2,4m) may be illustrated by the following equations:

R′(4n+2,4m)=R(4n+2,4m−1)

G′(4n+2,4m)=G(4n+2,4m)

B′(4n+2,4m)=B(4n+2,4m+1)

IR′(4n+2,4m)=[IR(4n+1,4m)+IR(4n+3,4m)]/2

The interpolation method of providing the red component R′(4n+2,4m+1), the green component G′(4n+2,4m+1), the blue component B′(4n+2,4m+1) and the IR component IR′(4n+2,4m+1) for the blue pixel at the coordinate (4n+2,4m+1) may be illustrated by the following equations:

R′(4n+2,4m+1)=[R(4n+2,4m−1)+R(4n+2,4m+3)]/2

G′(4n+2,4m+1)=[G(4n+1,4m+1)+G(4n+2,4m)+G(4n+2,4m+2)+G(4n+3,4m+1)]/4

B′(4n+2,4m+1)=B(4n+2,4m+1)

IR′(4n+2,4m+1)=[IR(4n+1,4m)+IR(4n+1,4m+2)+IR(4n+3,4m)+IR(4n+3,4m+2)]/4

The interpolation method of providing the red component R′(4n+2,4m+2), the green component G′(4n+2,4m+2), the blue component B′(4n+2,4m+2) and the IR component IR′(4n+2,4m+2) for the green pixel at the coordinate (4n+2,4m+2) may be illustrated by the following equations:

R′(4n+2,4m+2)=R(4n+2,4m+3)

G′(4n+2,4m+2)=G(4n+2,4m+2)

B′(4n+2,4m+2)=B(4n+2,4m+1)

IR′(4n+2,4m+2)=[IR(4n+1,4m+2)+IR(4n+3,4m+2)]/2

The interpolation method of providing the red component R′(4n+2,4m+3), the green component G′(4n+2,4m+3), the blue component B′(4n+2,4m+3) and the IR component IR′(4n+2,4m+3) for the red pixel at the coordinate (4n+2,4m+3) may be illustrated by the following equations:

R′(4n+2,4m+3)=R(4n+2,4m+3)

G′(4n+2,4m+3)=[G(4n+1,4m+3)+G(4n+2,4m+2)+G(4n+2,4m+4)+G(4n+3,4m+3)]/4

B′(4n+2,4m+3)=[B(4n+2,4m+1)+B(4n+2,4m+5)]/2

IR′(4n+2,4m+3)=[IR(4n+1,4m+2)+IR(4n+1,4m+4)+IR(4n+3,4m+2)+IR(4n+3,4m+4)]/4

The interpolation method of providing the red component R′(4n+3,4m), the green component G′(4n+3,4m), the blue component B′(4n+3,4m) and the IR component IR′(4n+3,4m) for the IR pixel at the coordinate (4n+3,4m) may be illustrated by the following equations:

R′(4n+3,4m)=[R(4n+2,4m−1)+R(4n+4,4m+1)]/2

G′(4n+3,4m)=[G(4n+2,4m)+G(4n+3,4m−1)+G(4n+3,4m+1)+G(4n+4,4m]/4

B′(4n+3,4m)=[B(4n+2,4m+1)+B(4n+4,4m−1)]/2

IR′(4n+3,4m)=IR(4n+3,4m)

The interpolation method of providing the red component R′(4n+3,4m+1), the green component G′(4n+3,4m+1), the blue component B′(4n+3,4m+1) and the IR component IR′(4n+3,4m+1) for the green pixel at the coordinate (4n+3,4m+1) may be illustrated by the following equations:

R′(4n+3,4m+1)=R(4n+4,4m+1)

G′(4n+3,4m+1)=G(4n+3,4m+1)

B′(4n+3,4m+1)=B(4n+2,4m+1)

IR′(4n+3,4m+1)=[IR(4n+3,4m)+IR(4n+3,4m+2)]/2

The interpolation method of providing the red component R′(4n+3,4m+2), the green component G′(4n+3,4m+2), the blue component B′(4n+3,4m+2) and the IR component IR′(4n+3,4m+2) for the IR pixel at the coordinate (4n+3,4m+2) may be illustrated by the following equations:

R′(4n+3,4m+2)=[R(4n+2,4m+3)+R(4n+4,4m+1)]/2

G′(4n+3,4m+2)=[G(4n+2,4m+2)+G(4n+3,4m+1)+G(4n+3,4m+3)+G(4n+4,4m+2]/4

B′(4n+3,4m+2)=[B(4n+2,4m+1)+B(4n+4,4m+3)]/2

IR′(4n+3,4m+2)=R(4n+3,4m+2)

The interpolation method of providing the red component R′(4n+3,4m+3), the green component G′(4n+3,4m+3), the blue component B′(4n+3,4m+3) and the IR component IR′(4n+3,4m+3) for the green pixel at the coordinate (4n+3,4m+3) may be illustrated by the following equations:

R′(4n+3,4m+3)=R(4n+2,4m+3)

G′(4n+3,4m+3)=G(4n+3,4m+3)

B′(4n+3,4m+3)=B(4n+4,4m+3)

IR′(4n+3,4m+3)=[IR(4n+3,4m+2)+IR(4n+3,4m+4)]/2

After performing interpolation on all pixels, the interpolation unit 20 is configured to output an image data DI which includes full-color brightness information associated with the brightness information of each pixel.

In another embodiment of the present invention, the buffer unit 30 in the optical recognition systems 100 and 200 may include more than two line buffers. Under such circumstance, the interpolation unit 20 can provide the missing components of each pixel by performing interpolation based on the brightness information of all neighboring pixels.

In the optical recognition systems 100 and 200, the correction unit 40 is configured to calibrate each pixel channel in the image data DI outputted by the interpolation unit 20 according to a configurable RGB-IR correction matrix, thereby outputting the RGB image and the IR image. The configurable RGB-IR correction matrix is depicted following this paragraph. In the configurable RGB-IR correction matrix, R, G, B, and IR represent the red pixel value, the green pixel value, the blue pixel value and the IR pixel value in the image data DI before calibration. RT, GT, BT, and IRT represent the red pixel value, the green pixel value, the blue pixel value and the IR pixel value in the RGB image and the IR image after calibration. C11˜C44 represent correction coefficients which may be acquired by shooting color cards with different optical brightness, thereby generating the calibrated RGB image and the calibrated IR image under different optical brightness. However, the implementation of the configurable RGB-IR correction matrix does not limit the scope of the present invention.

$$[ \begin{matrix}RT \\ GT \\ BT \\ IRT\end{matrix} ] = [ \begin{matrix}C 11 & C 12 & C 13 & C 14 \\ C 21 & C 22 & C 23 & C 24 \\ C 31 & C 31 & C 33 & C 34 \\ C 41 & C 42 & C 43 & C 44\end{matrix} ] * [ \begin{matrix}R \\ G \\ B \\ IR\end{matrix} ]$$

In the optical recognition system 100, the image signal processor 70 is configured to receive and analyze the RGB image and the IR image outputted by the correction unit 40, thereby providing a brightness parameter Y. The output decision unit 50 is configured to output one of the RGB image and the IR image to the computer visual processing unit 60 based on the brightness parameter Y.

In the optical recognition system 200, the output decision unit 50 is configured to receive the RGB image and the IR image directly from the correction unit 40. After analyzing the RGB image and the IR image, the output decision unit 50 is configured to output one of the RGB image and the IR image to the computer visual processing unit 60.

In conclusion, the present optical recognition system may be used in computer visual processing wherein a minimum of two line buffers are used for performing interpolation on RGB images and IR images using 4×4 kernel image sensor scheme. Therefore, the present invention can provide image characteristics for computers to perform image recognition without the need to implement complicated algorithms.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical recognition system for use in computer visual processing, comprising:
an image capturing device comprising a first 4×4 kernel image sensor which includes a first red pixel, a second red pixel, a first through an eighth green pixels, a first blue pixel, a second blue pixel, and a first through a fourth infrared (IR) pixels forming a first through a fourth scan lines adjacent to each other;
a buffer unit configured to store brightness information of at least two scan lines among the first through the fourth scan lines; and
an interpolation unit configured to provide missing components in each pixel according to the brightness information stored in the buffer unit, thereby outputting an image data which includes full-color brightness information associated with each pixel.

2. The optical recognition system of claim 1, wherein:
the first scan line sequentially includes the first green pixel, the first red pixel, the second green pixel and the first blue pixel;
the second scan line sequentially includes the first IR pixel, the third blue pixel, the second IR pixel and the fourth green pixel;
the third scan line sequentially includes the fifth green pixel, the second blue pixel, the sixth green pixel and the second red pixel; and
the fourth scan line sequentially includes the third IR pixel, the seventh green pixel, the fourth IR pixel, and the eighth green pixel.

3. The optical recognition system of claim 2, wherein the buffer unit includes two line buffers and the interpolation unit is further configured to:
provide a red component for a coordinate of the third green pixel by performing interpolation based on the brightness information associated with the first red pixel;
provide a green component for the coordinate of the third green pixel based on the brightness information associated with the third green pixel;
provide a blue component for the coordinate of the third green pixel by performing interpolation based on the brightness information associated with the second blue pixel; and
provide an IR component for the coordinate of the third green pixel by performing interpolation based on the brightness information associated with the first IR pixel and the second IR pixel.

4. The optical recognition system of claim 2, wherein the buffer unit includes two line buffers and the interpolation unit is further configured to:
provide a red component for a coordinate of the second IR pixel by performing interpolation based on the brightness information associated with the first red pixel and the second red pixel;
provide a green component for the coordinate of the second IR pixel by performing interpolation based on the brightness information associated with the second green pixel, the third green pixel, the fourth green pixel and the sixth green pixel;
provide a blue component for the coordinate of the second IR pixel by performing interpolation based on the brightness information associated with the first blue pixel and the second blue pixel; and
provide an IR component for the coordinate of the second IR pixel based on the brightness information associated with the second IR pixel.

5. The optical recognition system of claim 1, wherein:
the image capturing device further comprises a second 4×4 kernel image sensor which includes a third red pixel, a fourth red pixel, a ninth through a sixteenth green pixels, a third blue pixel, a fourth blue pixel, and a fifth through an eighth IR pixels forming the first through the fourth scan lines adjacent to each other;
the first scan line sequentially includes the first green pixel, the first red pixel, the second green pixel, the first blue pixel, the ninth green pixel, the third red pixel, the tenth green pixel, and the third blue pixel;
the second scan line sequentially includes the first IR pixel, the third blue, the second IR pixel, the fourth green pixel, the fifth IR pixel, the eleventh blue pixel, the sixth IR pixel and the twelfth green pixel;
the third scan line sequentially includes the fifth green pixel, the second blue pixel, the sixth green pixel, the second IR pixel, the thirteenth green pixel, the fourth blue pixel, the fourteenth green pixel and the fourth IR pixel; and
the fourth scan line sequentially includes the third IR pixel, the seventh green pixel, the fourth IR pixel, the eighth green pixel, the seventh IR pixel, the fifteenth green pixel, the eighth IR pixel, and the sixteenth green pixel.

6. The optical recognition system of claim 5, wherein the buffer unit includes two line buffers and the interpolation unit is further configured to:
provide a red component for a coordinate of the second red pixel based on the brightness information associated with the second red pixel;
provide a green component for the coordinate of the second red pixel by performing interpolation based on the brightness information associated with the fourth green pixel, the sixth green pixel, the eighth green pixel and the thirteen green pixel;
provide a blue component for the coordinate of the second red pixel by performing interpolation based on the brightness information associated with the second blue pixel and the fourth blue pixel; and
provide an IR component for the coordinate of the second red pixel by performing interpolation based on the brightness information associated with the second IR pixel, the fourth IR pixel, the fifth IR pixel and the seventh IR pixel.

7. The optical recognition system of claim 1, wherein:
the image capturing device further comprises a second 4×4 kernel image sensor which includes a third red pixel, a fourth red pixel, a ninth through a sixteenth green pixels, a third blue pixel, a fourth blue pixel, and a fifth through an eighth IR pixels forming the first through the fourth scan lines adjacent to each other;
the first scan line sequentially includes the ninth green pixel, the third red pixel, the tenth green pixel, the third blue pixel, the first green pixel, the first red pixel, the second green pixel, and the first blue pixel;
the second scan line sequentially includes the fifth IR pixel, the eleventh blue pixel, the sixth IR pixel, the twelfth green pixel, the first IR pixel, the third blue pixel, the second IR pixel and the fourth green pixel;
the third scan line sequentially includes the thirteenth green pixel, the fourth blue pixel, the fourteenth green pixel, the fourth red pixel, the fifth green pixel, the second blue pixel, the sixth green pixel, and the second red pixel; and
the fourth scan line sequentially includes the seventh IR pixel, the fifteenth green pixel, the eighth IR pixel, the sixteenth green pixel, the third IR pixel, the seventh green pixel, the fourth IR pixel, and the eighth green pixel.

8. The optical recognition system of claim 7, wherein the buffer unit includes two line buffers and the interpolation unit is further configured to:
provide a red component for a coordinate of the second blue pixel by performing interpolation based on the brightness information associated with the second red pixel and the fourth red pixel;
provide a green component for the coordinate of the second blue pixel by performing interpolation based on the brightness information associated with the third green pixel, the fifth green pixel, the sixth green pixel and the seventh green pixel;
provide a blue component for the coordinate of the second blue pixel based on the brightness information associated with the second blue pixel; and
provide an IR component for the coordinate of the second blue pixel by performing interpolation based on the brightness information associated with the first IR pixel, the second IR pixel, the third IR pixel and the fourth IR pixel.

9. The optical recognition system of claim 1, further comprising a correction unit configured to calibrate each pixel channel in the image data outputted by the interpolation unit according to a configurable RGB-IR correction matrix, thereby outputting an RGB image and an IR image.

10. The optical recognition system of claim 9, wherein the configurable RGB-IR correction matrix includes a plurality of correction coefficients which are acquired by shooting a pair of color card with different optical brightness.

11. The optical recognition system of claim 9, further comprising:
an image signal processor configured to receive and analyze the RGB image and the IR image outputted by the correction unit, thereby providing a brightness parameter; and
an output decision unit configured to output one of the RGB image and the IR image to a computer visual processing unit according to the brightness parameter.

12. The optical recognition system of claim 9, further comprising:
an output decision unit configured to receive and analyze the RGB image and the IR image outputted by the correction unit the RGB image, thereby outputting one of the RGB image and the IR image to a computer visual processing unit.

13. The optical recognition system of claim 1, wherein:
the image capturing device further comprises a second 4×4 kernel image sensor which includes a third red pixel, a fourth red pixel, a ninth through a sixteenth green pixels, a third blue pixel, a fourth blue pixel, and a fifth through an eighth IR pixels forming a fifth through an eighth scan lines adjacent to each other;
the fifth scan line sequentially includes the ninth green pixel, the third red pixel, the tenth green pixel, and the third blue pixel;
the sixth scan line sequentially includes the fifth IR pixel, the eleventh blue pixel, the sixth IR pixel, and the twelfth green pixel;
the seventh scan line sequentially includes the thirteenth green pixel, the fourth blue pixel, the fourteenth green pixel, and the fourth red pixel; and
the eighth scan line sequentially includes the seventh IR pixel, the fifteenth green pixel, the eighth IR pixel, and the sixteenth green pixel.
